(19) United States
(12) Patent Application Publication
(10) Pub. No.: US 2024/0057701 A1
(43) Pub. Date: Feb. 22, 2024

(54) 3D KNIT SPACESUIT SLEEVE WITH MULTIFUNCTIONAL FIBERS AND TUNABLE COMPRESSION

(71) Applicant: Massachusetts Institute of Technology, Cambridge, MA (US)

(72) Inventors: Dava J. NEWMAN, Cambridge, MA (US); Skylar TIBBITS, Nahant, MA (US); Hugh M. HERR, Concord, NH (US); Svetlana BORISKINA, Winchester, MA (US); Lavender TESSMER, Cambridge, MA (US); Volodymyr KOROLOVYCH, Boston, MA (US); Atharva SAHASRABUDHE, Cambridge, MA (US); Ganit GOLDSTEIN, Cambridge, MA (US); Jesus Guillermo HERRERA ARCOS, Somerville, MA (US); Rachel BELLISLE, Cambridge, MA (US); Cody PAIGE, Medford, MA (US); Christopher SHALLAL, Cambridge, MA (US)

(73) Assignee: Massachusetts Institute of Technology, Cambridge, MA (US)

(21) Appl. No.: 18/452,752

(22) Filed: Aug. 21, 2023

Related U.S. Application Data
(60) Provisional application No. 63/373,194, filed on Aug. 22, 2022.

(51) Int. Cl. A41D 27/10; B32B 5/06; B32B 7/05; B32B 7/02; B32B 5/02; B32B 5/26; A41D 13/12; B64G 6/00

(52) U.S. Cl. CPC A41D 27/10; B32B 5/073; B32B 7/05; B32B 7/02; B32B 5/026; B32B 5/26; A41D 13/1236; B64G 6/00; B32B 2437/00; B32B 2307/51; B32B 2250/20; B32B 2262/0253; B32B 2307/7376; B32B 2571/00; A41D 2500/10

(57) ABSTRACT

Disclosed herein is a wearable article, comprising a fabric. In some embodiments, the fabric comprises an inner material layer which forms an inner surface of the wearable article, an outer material layer which forms an outer surface of the wearable article; and one or more intermediate material layers disposed between the inner and outer material layers. In some embodiments, the inner, outer, and one or more intermediate material layers are knitted together to provide a combination of two or more of: two or more compression zones; two or more mobility zones; two or more materials; or one or more electronic components.

### CROSS REFERENCE SECTION

This application claims the benefits of U.S. Provisional Application No. 63/373,194 filed on Aug. 22, 2022.

### STATEMENT REGARDING FEDERALLY SPONSORED RESEARCH

This invention was made with government support under W911 NF-13-D-0001 awarded by the U.S. Army Research Office, and N68335-21-C-0489 awarded by the Office of Naval Research. The government has certain rights in the invention.

### BACKGROUND

Spacesuit designs differ in their technical strategies for maintaining pressure on the body surface in a vacuum environment. One common spacesuit design is a gas pressurization suit, wherein pressure is achieved by providing an airtight environment with non-permeable layers and gas-pressure. Another design is a mechanical counter pressure (MCP) suit which alleviates the challenges of mobility and airtightness by providing mechanical pressure on the body through direct contact with the material. MCP suits rely on elastic fibers, which have the ability to conform to the complex motion and geometry of a user's body while maintaining a desired pressure. However, MCP suits often lack control of local fabric properties because they are assembled from homogeneous sheet materials. Such homogeneous sheet materials are often formed from multiple layers of elastic mesh fabric and the material becomes difficult to stretch when compiled into a multilayer construction. Accordingly, convex bends (e.g., joints such as knees and elbows) exhibit resistance to mobility due to thickness of the elastic fabric and inability to differentiate between circumferential and longitudinal strain in the material.

### SUMMARY

Disclosed herein is a wearable article. According to one aspect of the disclosure, the wearable article comprises a fabric comprising: an inner material layer, which forms an inner surface of the wearable article; an outer material layer, which forms an outer surface of the wearable article; and one or more intermediate material layers disposed between the inner material layer and outer material layers. In some embodiments, the inner, outer, and one or more intermediate material layers are knitted together to provide a combination of two or more of: two or more compression zones; two or more mobility zones; two or more materials; or one or more electronic components. In some embodiments, the inner, outer and one or more intermediate material layers knitted together with flatbed knitting to provide a combination of two or more of: two or more compression zones; two or more mobility zones; two or more materials; or one or more electronic components.

### DESCRIPTION OF THE SEVERAL VIEWS OF THE DRAWINGS

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principals of the concepts described herein. Like reference numerals designate corresponding parts throughout the different views. Furthermore, embodiments are illustrated by way of example and not limitation in the figures, in which:

FIG. 1 is a perspective view of a wearable article;

FIG. 2 is a perspective view of a fabric for a wearable article, comprising an inner material layer, an outer material layer, and an intermediate material layer;

FIG. 3 is a side view of a diagram of an inner material layer for a fabric;

FIG. 4 is a side view of a diagram of an intermediate material layer for a fabric;

FIG. 5 is a side view of a diagram of an outer material layer for a fabric;

FIG. 5A is a perspective view of a mobility region;

FIG. 5B is a perspective view of a mobility region;

FIG. 6 is a side view of samples for collecting pressure data;

FIG. 7 is a graph of average pressure vs. test cylinder circumference in the samples of FIG. 6, showing the relationship between cuff size, elastic fabric, and reduction in the quantity of fibers;

FIG. 8 is a perspective view of an inner, outer, and one or more intermediate material layers, such as the material layers of FIG. 2, knitted together to provide a channel;

FIG. 8A is a perspective view of an inner, outer, and one or more intermediate material layers, such as the material layers of FIG. 2, knitted together to provide a channel access;

FIG. 8B is a perspective view of an inner, outer, and one or more intermediate material layers, such as the material layers of FIG. 2, knitted together to provide a pocket;

FIG. 8C is a perspective view of an inner, outer, and one or more intermediate material layers, such as the material layers of FIG. 2, knitted together to provide an edge flap;

FIG. 9 is a side view of a diagram of different locations of electronic components for a wearable article, such as the wearable article of FIG. 1;

FIG. 10 is a perspective view of a closing mechanism for a wearable article, such as the wearable article of FIG. 1;

FIG. 10A is a perspective view of a first closing mechanism and a second closing mechanism for a wearable article, such as the wearable article of FIG. 1; and

FIG. 10B is a perspective view of a second closing mechanism for a wearable article, such as the wearable article of FIG. 1.

### DETAILED DESCRIPTION

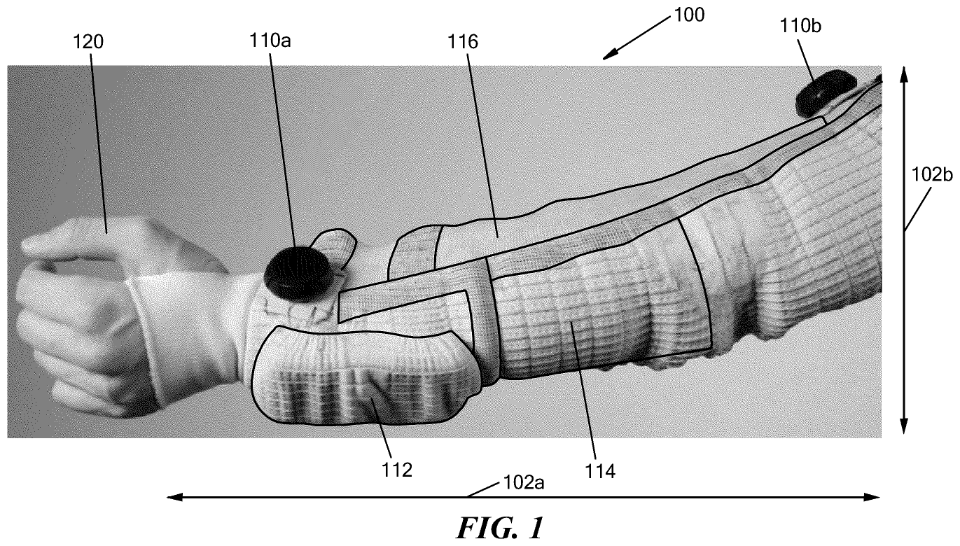

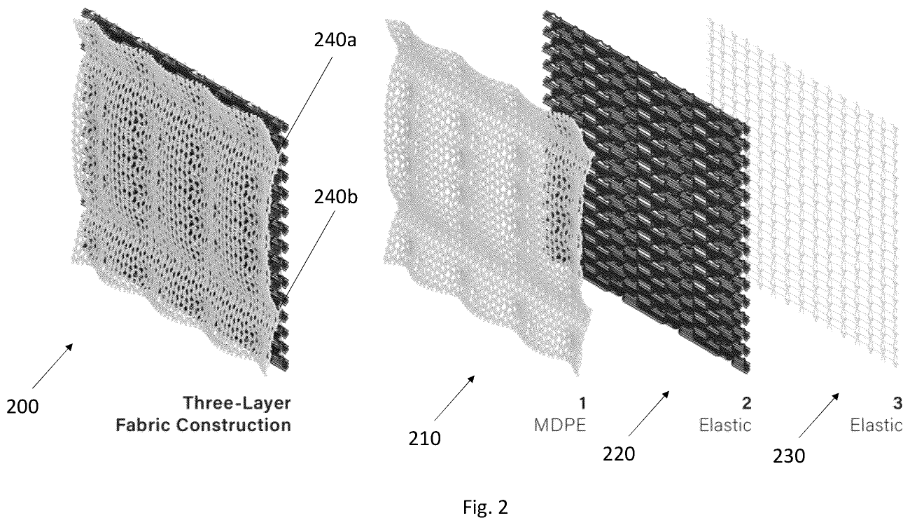

FIG. 1 illustrates a wearable article 100 disposed over (or positioned on) an arm of a user 120. The wearable article comprises a fabric 114 comprising an inner material layer, an outer material layer, and one or more intermediate material layers, which will be described below in relation to FIG. 2. The inner, outer, and one or more intermediate material layers are knitted together to provide a combination of two or more of: two or more compression zones; two or more mobility zones; two or more materials; or one or more electronic components.

The wearable article 100 may be a sleeve, as shown in FIG. 1, designed to fit over a user's arm and apply pressure thereto. The general concepts and structures disclosed herein can be used in conjunction with other types of wearable garments, such as wearable articles worn on the leg or torso. For example, embodiments of the present disclosure may be integrated into vests, headbands, gloves, socks, etc. In some cases, the wearable article may be designed to be worn over an entire limb (e.g., a whole leg or a whole arm), just a part of a limb (e.g., an upper arm, lower arm, thigh, shin, etc.). In alternative embodiments, the wearable article may be designed to fit over an entire body (e.g., a spacesuit designed to be worn over the user's entire body or over the body up until the neck or head, where a helmet may be situated).

Additionally, along a length 102a of the wearable article 100, a width 102b decreases in order to fit the user (e.g., if the wearable article is a sleeve it may be wider towards the elbow and smaller at the wrist, meaning width 102b of the wearable article 100 decreases along the length 102a of the forearm). Accordingly, along the user (e.g., a leg, arm, torso) the width 102b may increase or adjust along the length 102a as desired to best fit the user 120 and the intended purpose of the wearable article 100.

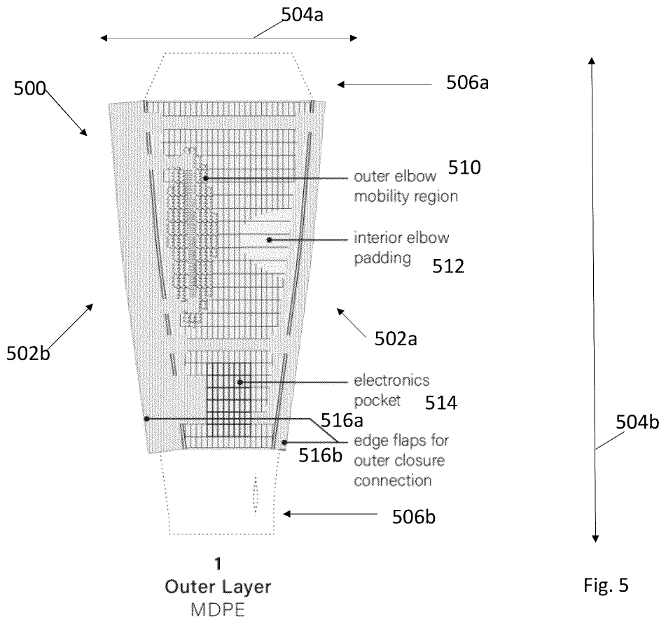

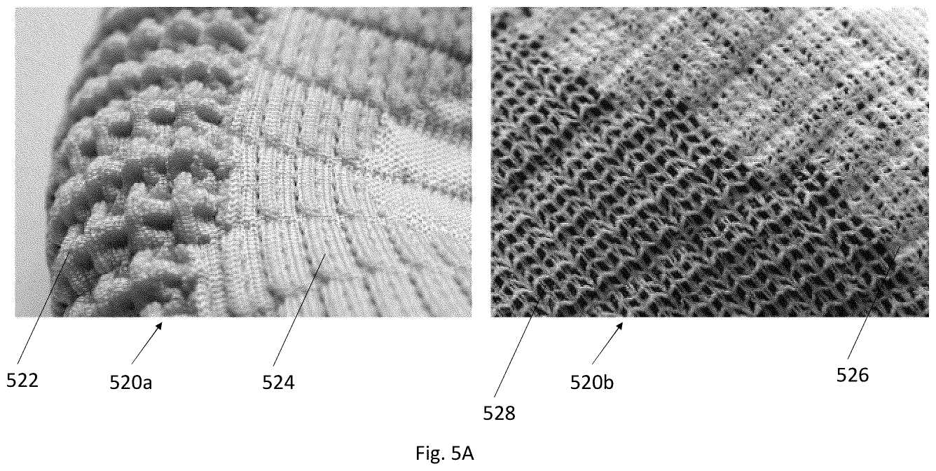

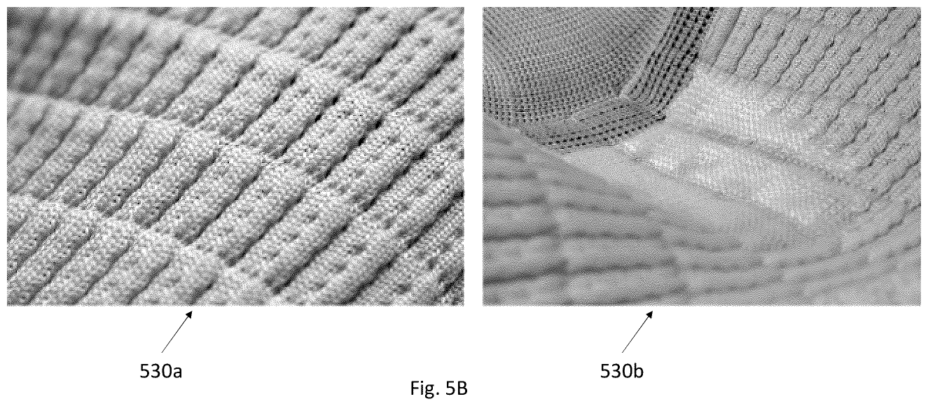

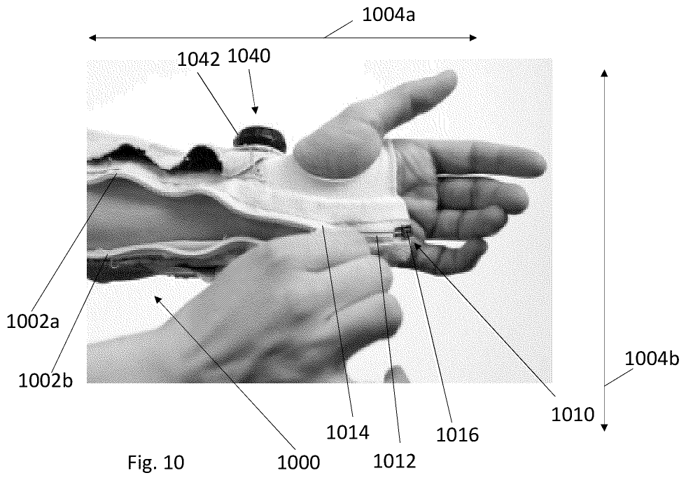

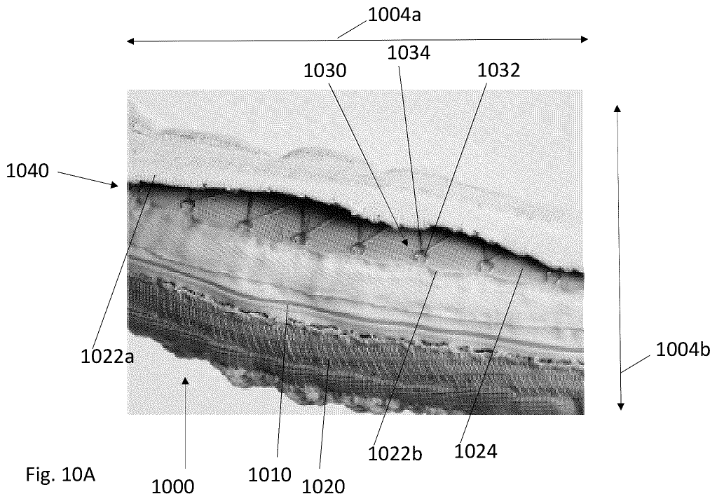

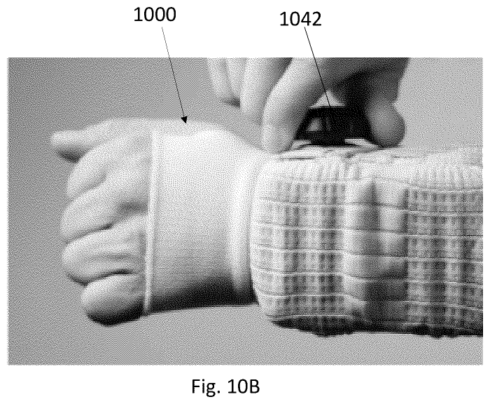

The wearable article 100 includes a fabric 114 knitted to form two or more compression zones, two or more materials, or one or more electronic components. The wearable article 100 includes a first mobility region 116 designed to provide degrees of joint mobility, while maintaining mechanical pressure. A second mobility region 112 includes a padding applied to by fibers and designed to support the user 120. The mobility regions will be described below in relation to FIGS. 5-5B and may be referred to herein as a padded region and/or a mechanical counter pressure region. The wearable article 100 includes a closing mechanism 110a, 110b designed to support donning and doffing of the wearable article 100, which will be described below in relation to FIGS. 10-10B.

To form the wearable article 100, a three dimensional scan of the user's shape is mapped onto a two dimensional pattern. A pattern for the users unique shape is formed, in part by determining the distribution of zones, layers and components. The mapped pattern was then divided into segments to estimate mobility needs in the segments. For example, if the wearable article is a sleeve then the mobility regions may include primary regions, such as: the lower arm; elbow, including the anterior and posterior elbow; and upper arm. The horizontal measurements of the user define the reduction of the pattern of the knit structure, while maintaining the scan's precise placement of the pattern. The pattern dimensions have unique zones (which may be customized to the user) which are then converted to a pattern file.

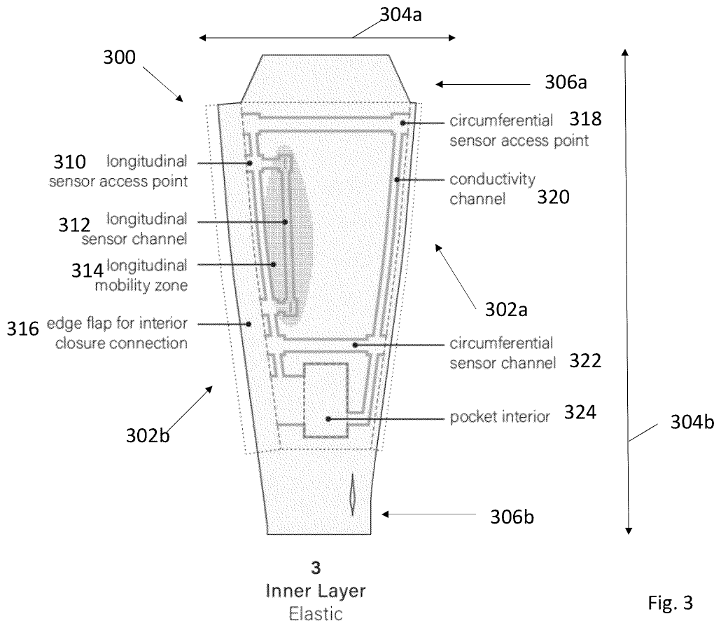

The pattern file is then prepared for the specific fiber materials that serve unique functions in the knit fabric, such as the materials discussed below in relation to the material layers in FIGS. 3-5B. The pattern file is then processed to generate a knitting file that address the user's unique dimensions and the desired benefits, which will be discussed below, through a fine-tuned placement of materials and knit structures. The fabric is composed of multiple material layers that are concurrently knit. Fabrics are composed of rows of interlocking loops, called “stitches”, where various choices can be made to locate different types of stitches to organize the material on the fabric. Knitting the layers, such as the layers 210, 220, 230 to form the fabric 200 shown in FIG. 2, may be performed through a computerized numeric control (CNC) knitting machine. A CNC knitting machine combines multiple materials, designate localized fabric behavior, and integrates multi-layered geometry together in one seamless fabric.

In addition to employing specific fiber materials, the layers are capable of separating and merging with each other in cross section, enabling the formation of two or more of: two or more compression zones; two or more mobility zones; two or more materials; or one or more electronic components. Once knitted, a closing mechanism is installed and the sensing components assembled.

The wearable article provides a range of benefits, including: applying pressure on the user; providing ease of mobility; increased speed of donning and doffing; potential for thermal and radiation protection; and the ability to integrate fiber-based sensing systems. Said benefits are provided through a seamless fabric knitted to integrate multiple materials, material layers, and functions that are tailored to different regions of the user.

In testing, the wearable article demonstrated variations in the behavior of the fabric across the arm and the overall viability of applying a knitting technique to achieve various regions of differing compression and mobility requirements. To evaluate the wearable article, pressure was measured, sensors with 20 mm diameter were placed on the inside and outside of the elbow joint to measure the consistency of pressure in different regions as the joint is moved and flexed underneath the wearable article. The wearable article demonstrated pressures ranging from 4-8 kPa. Alternative samples of the wearable article demonstrated pressures of nearly 20 kPa, demonstrating how the knitting technique can potentially be effective for generating the full amount of pressure required for a vacuum environment, such as the environment of space. The multi-layer surface geometry of the wearable article was able to accommodate the installation of sensors and corresponding layout of conductive connections and pathways, and successfully accommodated access points for connecting and adjusting sensor components. The wearable article comprises customizable compression gradients and mobility zones which deliver a number of potential applications.

FIG. 2 illustrates a fabric 200 for a wearable garment, such as the wearable article 100 shown in FIG. 1. Fabric 200 comprises a three layer fabric construction including an inner material layer 230, an intermediate material layer 220, and an outer material layer 210. The intermediate material layer 220 is disposed between the inner material layer 230 and the outer material layer 210. In some embodiments there may be more than one intermediate material layer 220.

The inner material layer 230, outer material layer 210 and intermediate material layer 220 knitted together, using such techniques as those described above in relation to FIG. 1, to form the fabric 200. A first knitting stitch 240a and a second knitting stitch 240b are positioned on the fabric 200. The inner material layer 230, outer material layer 210, and intermediate material layer 220 are each contacted by stitches 240a, 240b, which work to knit the material layers 210, 220, 230 together to form the fabric 200.

Different stitch types, such as “tuck” and “float” can enable the placement of material within the fabric without looping. Stitches 240a, 240b may be configured to provide one or more of a front stitch, a tuck stitch, or a float stitch. The organization of stitches and stitch types controls the local knit structure, which can be leveraged to embed different fabric behaviors into different regions. Furthermore, stitches can be deployed along with material selections to differentiate and fine-tune every area of the fabric. Deployed into more advanced configurations, stitches 240a, 240b can be leveraged as a tool to affect behavior and the form of a fabric.

Each layer 210, 220, 230 is independently capable of a range of variability in the pattern design, enabling the fabric and ultimately the wearable garment to adapt to the dimensions of the user and the desired functional requirements allowing properties of the fabric to be differentiated across the structure. For example, the inner material layer 230 may comprise a thin elastic layer against the skin, the intermediate material layer 220a comprises a thicker transverse layer of elastic fibers, and the outer material layer 210 comprises a protective polyethylene layer on the exterior.

FIG. 3 discloses a side view of a diagram of an inner material layer 300 for a fabric, such as the fabric 200 shown in FIG. 2. Along a width 304a of the inner material layer 300 is an inner area 302a along an inside of the user facing towards the user and an outer area 302b along an outer side of the user facing away from the user. Along a length 304b of the inner material layer 300 is a top 306a portion and a bottom 306b portion.

The inner material layer 300 is positioned closest to a user and helps in part to address the mobility constraints of the wearable article. The interaction between the inner material layer 300 and the outer material layer, such as outer material layer 500 shown in FIG. 5, together address the mobility requirements. The mobility constraints may stem from the high level of pressure applied to the user while in outer space. The wearable article enables joint mobility while maintaining the required level of compression, which can present significant challenges in traditional spacesuit fabrication. By manipulating of knit structure, through knitting techniques, a range of different elasticities can be embedded in different regions of the fabric in both elastic and non-elastic materials. In non-elastic layers, range of elasticity is enabled through a region of higher surface area surrounding the mobility regions, which will be discussed below in relation to the outer material layer 500 in FIG. 5.

In elastic layers, specific regions allow for higher stretch, such as in the longitudinal mobility zone 314, the placement of which may correspond to the outer elbow mobility region 510 of FIG. 5, wherein the wearable garment requires a greater amount of elasticity. The longitudinal mobility zone 314 is differentiated by adding twice as many rows of elastic stitches, increasing the potential for longitudinal strain. Conversely, surface area and elastic stretch are restricted in the interior elbow region, such as the inner elbow mobility region 512 in FIG. 5, by adding fewer stitches within the same area of the pattern. The inner material layer 300 may be formed from said elastic, such as a polymer, a copolymer, or a polyamide.

The inner material layer 300 comprises a one or more access points 310, 318, one or more channels 312, 320, 322, one or more zones 314, one or more connections 316, and a pocket interior 324. A first longitudinal access point 310 is positioned along the inner area 302a by the top 306a of the inner material layer 300. A longitudinal sensor channel 312 is connected to first longitudinal access point 310 and runs along a longitudinal mobility zone 314 along the inner area 302a moving from the top 306a to the bottom 306b of the inner material layer 300. An edge flap for an interior closure connection 316 is positioned along the inner area 302a moving from the top 306a to the bottom 306b of the inner material layer 300 (the closure mechanism will be described in conjunction with FIGS. 10-10B).

A circumferential sensor access point 318 moves along the width 304a from the outer area 302b to the inner area 302a by the top 306a of the inner material layer 300. A circumferential channel 322 moves along the width 304a from the outer area 302b to the inner area 302a. A conductivity channel 320 moves from the top 306a to the bottom 306b along the length 304b of the outer area 302b. A pocket interior 324 is positioned by the bottom 306b of the inner material layer 300.

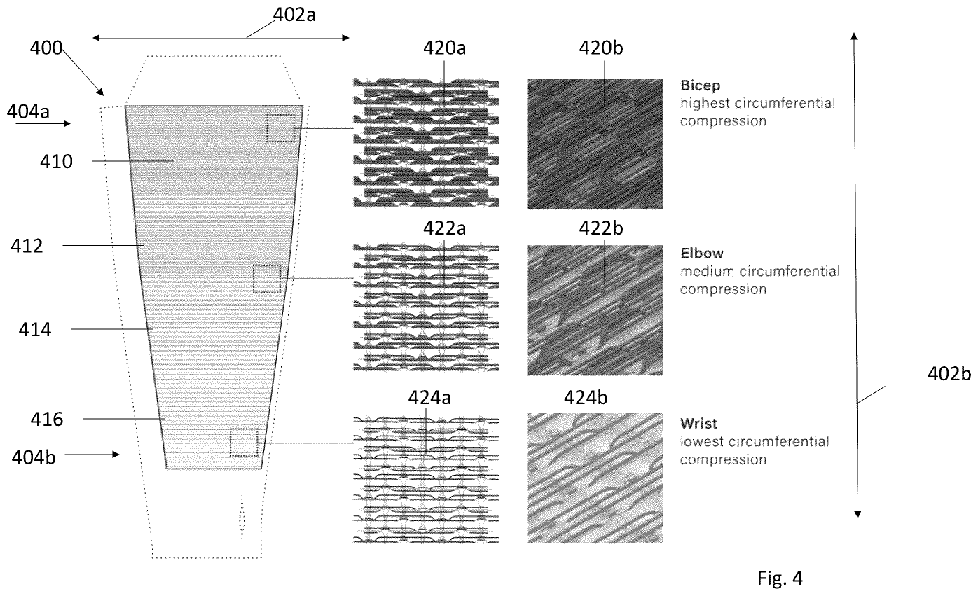

FIG. 4 illustrates a side view of a diagram of an intermediate material layer 400 for a fabric, such as the fabric 200 shown in FIG. 2. Along a length 402b of the intermediate material layer 400 is a top 404a portion and a bottom 404b portion. Moving along the length 402b from the top 404a portion to the bottom 404b portion, the width 402a of the intermediate material layer 400 decreases in order to fit and apply compression pressure to the user.

The intermediate material layer 400 addresses the compression requirements for the wearable article. The intermediate material layer 400 applies a constant reduction factor across the varying circumferences of the user by modulating the compression strength power required to maintain a uniform compression force. The compression pressure strength may be measured along the circumference of the wearable garment, or in the width 402a direction. In order to increase or decrease the compression strength power of the intermediate material layer 400, the quantity of cumulative strands may be varied.

The intermediate material layer 400 may have different zones 410, 412, 414, 416 of compression. A first zone 410 is located at the top 404a of the intermediate material layer 400. A second zone 412 is located next to the first zone 410, but moving down the length 402b of the intermediate material layer 400 towards the bottom 404b. A third zone 414 is located next to the second zone 412, but moving down the length 402b of the intermediate material layer 400 towards the bottom 404b. A fourth zone 416 is located next to the third zone 414, but moving down the length 402b of the intermediate material layer 400 towards the bottom 404b. In some embodiments, the zones 410, 412, 414, 416 may all exhibit different or the same compression pressure strength. The zones 410, 412, 414, 416 may alternative compression pressure strength as they move down the length 402b of the intermediate material layer 400 towards the bottom 404b.

The zones 410, 412, 414, 416 may decrease in compression pressure strength as they move down the length 402b of the intermediate material layer 400 towards the bottom 404b. The compression pressure strength corresponds to the pressure exerted along the circumference of the wearable garment, meaning along the width 402a of the intermediate material layer 400. Meaning the first zone 410 has a stronger compression pressure strength compared to the second zone 412. The second zone 412 has a stronger compression pressure strength compared to the third zone 414. The third zone 414 has a stronger compression pressure strength compared to the fourth zone 416. Accordingly, the zones create a gradient of compression pressure strength as they move from the top 404a down the length 402b of the intermediate material layer 400 towards the bottom 404b.

The different zones 410, 412, 414, 416 of compression pressure strength are formed by varying the quantity of cumulative strands in the intermediate material layer 400. The intermediate material layer 400 is formed from a series of horizontal tuck stitches, inserting a quantity of strands into the intermediate material layer 400. Accordingly, the density of the horizontal courses of elastic fiber can be increased or decreased based on the desired compression force and the circumference of the wearable garment. The desired compression force can be manipulated by adjusting the number of elastic strands that are placed inside each knitting row.

Views 420a, 420b, 422a, 422b, 424a, 424b of the strands in the intermediate material layer 400 demonstrate how varying the quantity of cumulative strands in the intermediate material layer 400 the compression pressure strength can be varied. By increasing or decreasing the quantity of cumulative strands in the intermediate material layer 400 the compression pressure strength in each zone 410, 412, 414, 416 can be increased or decreased.

The quantity and distribution of strands in the first zone 410 is illustrated in a top view 420a and a perspective view 420b. The first zone 410 has a highest compression strength along the width 402a of the intermediate material layer 400, in comparison to the other zones 412, 414, 416, accordingly it has the highest quantity and distribution of strands.

The quantity and distribution of strands in the second zone 412 and the third zone is illustrated in a top view 422a and a perspective view 422b. The second zone 410 has a second highest compression strength along the width 402a of the intermediate material layer 400, in comparison to the other zones 410, 414, 416, accordingly it has the second highest quantity and distribution of strands. The third zone may have a similar or the same compression strength, accordingly it is denoted with the same top and perspective views 422a, 422b.

The quantity and distribution of strands in the fourth zone 416 is illustrated in a top view 424a and a perspective view 424b. The fourth zone 410 has the lowest compression strength along the width 402a of the intermediate material layer 400, in comparison to the other zones 410, 412, 414, accordingly it has the least quantity and lowest distribution of strands. In order to maintain pressure, the first zone 410 contains twice as many elastic fibers per unit area as the fourth zone 416.

The intermediate material layer 400 may be formed from said elastic, such as a polymer, a copolymer, or a polyamide. The inner material layer 300 and the intermediate material layer 400 may be formed from the same or different materials. The inner material layer 300 may be thinner or the same thickness as the intermediate material layer 400. The intermediate material layer 400 may be thicker than the inner material layer 300.

In addition to the intermediate material layer 400, there are many factors that affect the necessary amount of pressure for the desired application. Other layers may address the compression requirements, for example the shape and surface of the user contains many concavities (e.g., behind the knee or the inside of the elbow), these regions create additional challenges for fabrication and use. Additional layers, such as the mobility regions shown in FIG. 5, may provide pressure through integrated padding to fill the concave areas.

FIG. 5 illustrates a side view of a diagram of an outer material layer 500 for a fabric, such as the fabric 200 shown in FIG. 2. The outer material layer 500 creates a continuous protective barrier with radiation shielding capability, while maintaining the seamless integration for compression and mobility requirements. Along a width 504a of the outer material layer 500 is an inner area 502a along an inside of the user facing towards the user and an outer area 502b along an outer side of the user facing away from the user. Along a length 504b of the outer material layer 500 is a top 506a portion and a bottom 506b portion.

Outer material layer 500 includes a number of different mobility regions 510, 512, pockets 514, and edge flaps 516a, 516b. An outer elbow mobility region 510 is positioned along the outer area 502b of the outer material layer 500, extending along the length 504b and the width 504a. An inner elbow mechanical counter pressure region 512 is positioned along the inner area 502a of the outer material layer 500, extending along the length 504b and the width 504a. A pocket 514, extending along the length 504b and the width 504a, is positioned along the length 504b towards the bottom 506b of outer material layer 500. Towards the bottom 506b are two edge flaps 516a, 516b for outer closer connection (the closure mechanism will be described in conjunction with FIGS. 10-10B). A first edge flap 516a is positioned on the outer area 502b and a second edge flap 516b is positioned on the inner area 502a, both moving along the length 504b the outer material layer 500 from the top 506a to the bottom 506b.

FIGS. 5A and 5B illustrate perspective views of mobility regions embedded into the outer material layer. FIG. 5A is a perspective view of a padded region along an outer material layer, such as the outer material layer 500 of FIG. 5. A first view 520a demonstrates extra courses of fibers 522 that form a mobility region with a higher surface area compared to fibers 524 which form the outer material layer. Through these additional fibers 522, pleats and folds are created that expand and collapse with motion of the elbow. In a second view 520b, a mobility region 526 is formed from fibers woven into the fibers 528 that form the outer material layer, such as the outer material layer 500 of FIG. 5. The surface area and elastic stretch are restricted in mobility region 526, which may correspond to the inner elbow mechanical counter pressure region 512, by adding fewer stitches within the same area of the pattern.

FIG. 5B is a perspective view 530a, 530b of a mobility region in the outer material layer, such as the outer material layer 500 in FIG. 5. The interaction between the material layers addresses the mobility requirements. Accordingly, the outer material layer 500 is connected to the inner material layer and intermediate material layer, such as the inner material layer 300 in FIG. 3 and the intermediate material layer 400 in FIG. 4, through intermittent tuck stitches reaching to the opposite layers, forming a rectangular quilted appearance, as demonstrated in a first perspective view 530a. The rectangular pattern negotiates the surface area differences between the inner material layer and intermediate material layer and outer material layer, building a high enough surface area throughout the inelastic material system that all the materials are able to flex together, as demonstrated in a second perspective view 530b.

The outer material layer 500 comprises MDPE, linear low density polyethylene (LLDPE), bicomponent fiber, or polyamide. In part through a 892-denier Medium-Density Polyethylene (MDPE) multifunctional yarn, the outer material layer 500 creates a protective barrier over the user. Polyethylene is a versatile material with multiple functions related to space garments. Polyethylene molecules are composed of repeating units of two carbon atoms linked to four hydrogen atoms and have high hydrogen content to efficiently absorb and disperse harmful radiation. The multifunctional polyethylene fabric platform also offers other unique advantages beyond shielding from ionizing radiation, including: stain-resistance; antibacterial properties; passive heat management; and low weight in the spacesuit industry. The diameter of polyethylene yarn is commensurate with the conventional sizing of polyester, nylon, or hybrid stretchable yarns thus making polyethylene yarn immediately capable of being integrated into standard textile industry processes. Initially soft and pliable, the MDPE fiber is heat-set at 85 degrees Celsius after knitting which rigidifies the material and reduces the large porosity in the knit structure. Padded areas that contain LLDPE material further enhance radiation protection properties of the sleeve.

Further supporting the barrier are a number of different mobility regions 510, 512 integrated into the outer material layer 500 and consist of a heat-responsive bicomponent fiber. The mobility regions are formed from a 72-filament, 290-denier, bicomponent fiber, containing both linear low density polyethylene (LLDPE) and Nylon polymers in its cross section. The bicomponent fiber enables selective placement of padded areas directly in a knit fabric without any post-insertion or assembly. Before knitting, the bicomponent fiber begins as a smooth, flat fiber, but responds to heat after knitting by becoming bulky and pillow-like.

Furthermore, the polyethylene fibers may be doped with nanomaterials such as e.g., metal-based powders. This doping may provide additional benefits such as improved radiation shielding, and abrasion resistance. Additionally, the doping may provide color or colorful patterns to the wearable article.

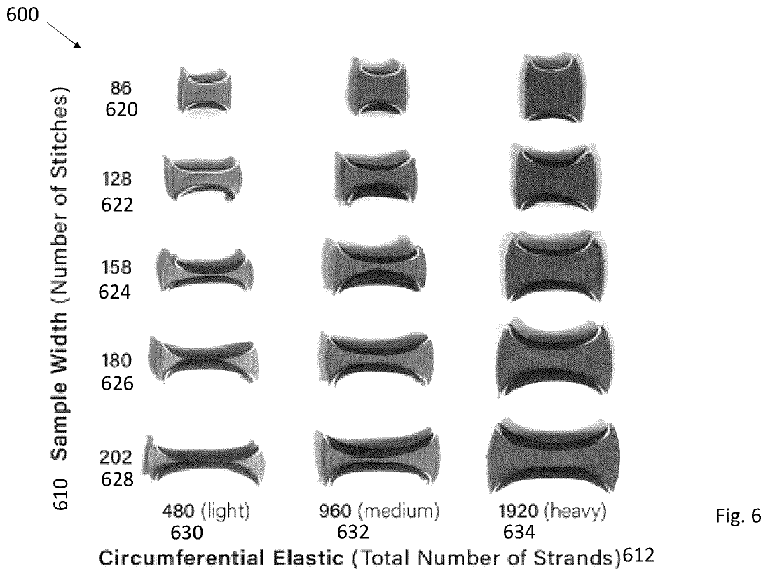

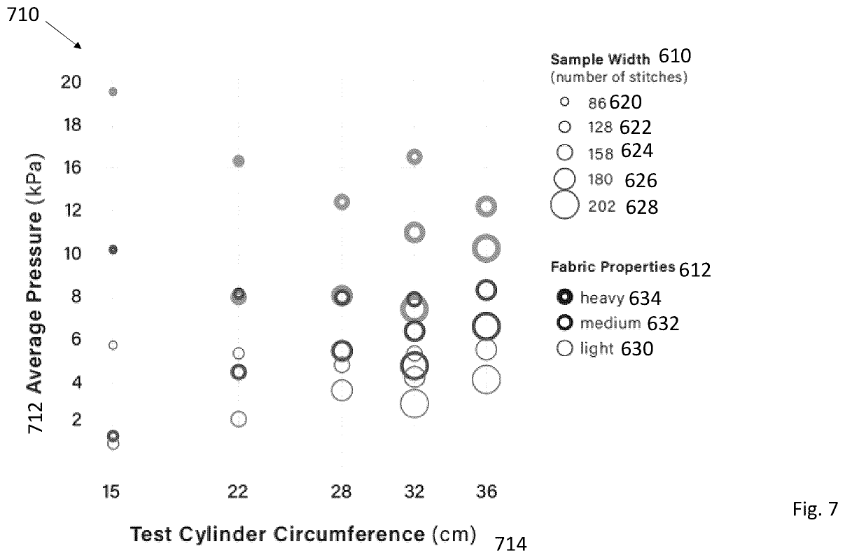

FIG. 6 illustrates a side view of samples for collecting pressure data, such as the pressure data shown in FIG. 7. The samples are organized by sample width 610 and by fabric properties 612. The sample width 610 is measured by the number of stitches in the sample, accordingly the samples are organized by increasing numbers of stitches: 86 stitches 620; 128 stitches 622; 158 stitches 624; 180 stitches 626; and 202 stitches 628. The fabric properties 612 is measured based on circumferential elastic (the total number of strands), accordingly the samples are organized by numbers of strands: 480 strands 630, denoted light circumferential elastic; 960 strands 632, denoted medium circumferential elastic; and, 1920 strands 634, denoted heavy circumferential elastic.

FIG. 7 is a graph that compares an average pressure 712 to a test cylinder circumference 714 in the samples shown in FIG. 6. The average pressure 712 is measured in kPa, increasing along the y-axis from 2 kPa to 20 kPa. The test cylinder circumference 714 is measured in cm, increasing along the x axis from 15 cm to 36 cm. Fabric properties, corresponding to the fabric properties 612 in the sample width, is organized on the graph by the number of strands 630, 632, 634. Sample width 610 is organized on the graph by the number of stitches 620, 622, 624, 626, 628. FIG. 7 demonstrates the relationship between cuff size, elastic fabric, and reduction in the quantity of fibers.

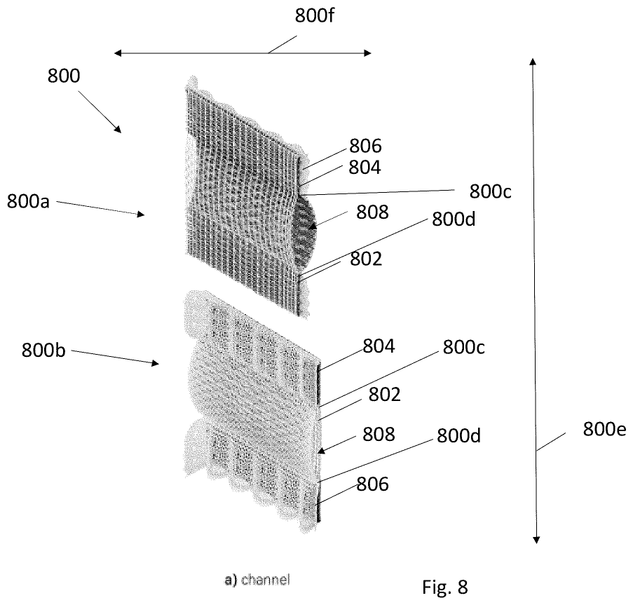

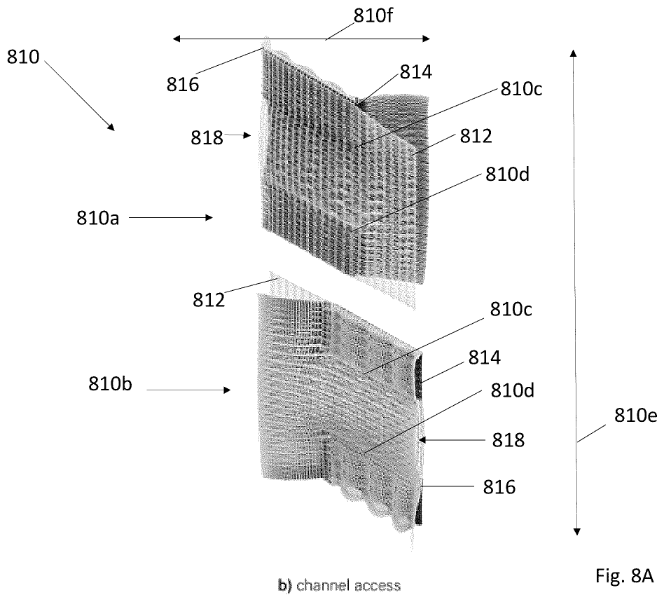

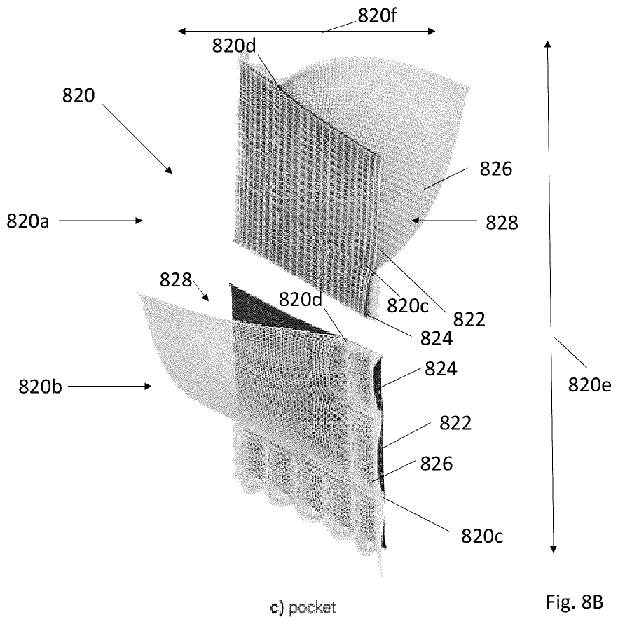

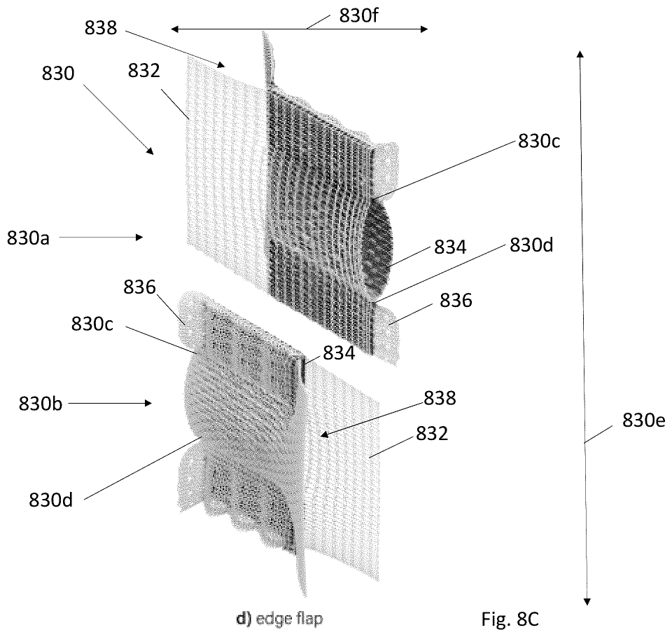

FIG. 8-8C is a perspective view of an inner material layer 802, 812, 822, 832, an outer material layer 806, 816, 826, 836, and one or more intermediate material layers 804, 814, 824, 834, such as the material layers of FIG. 2. Using knitting can enable the formation and manipulation of the geometric organization of the fabric and wearable garment. A network of interconnected channels, channel accesses, pockets, and edge flaps may be formed along the wearable garment, between the inner layer and the others.

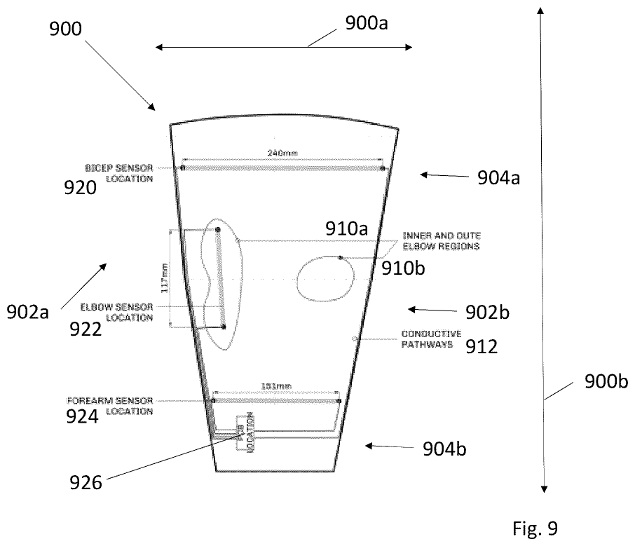

FIG. 8 is a perspective view of a fabric 800 comprising an inner material layer 802, an outer material layer 806, and one or more intermediate material layers 804 knitted through stitches 800c, 800d together to provide a channel 808. The channel 808 may accommodate the strain sensors, such as the sensors shown in FIG. 9, towards the user and establish the required pathways for electronic conductivity. The channel 808 extends along both a length 800e and a width 800f of the fabric 800. In a first view 800a, the inner material layer 802 is positioned on the outside, while the outer material layer 806 is on the inside. In a second view 800b, the inner material layer 802 is positioned on the outside, while the outer material layer 806 is on the inside.

The stitches 800c, 800d extend through all of the material layers 802, 804, 806. A first stitch 800c is positioned a distance away from a second stitch 800d along the length 800e of the fabric. The channel 808 extends between the first stitch 800c and the second stitch 800d along the length 800e of the fabric 800. The inner material layer 802 forms one side of the channel 808, while the intermediate material layers 804 and the outer material layer 806 together form the other side. The intermediate material layers 804 and the outer material layer 806 together extend out from the inner material layer 802 along the width 800f to form the channel 808.

FIG. 8A is a perspective view of a fabric 810 comprising an inner material layer 812, an outer material layer 816, and one or more intermediate material layers 814 knitted through stitches 810c, 810d together to provide a channel access 818. A plurality of channel accesses may be positioned on the fabric 810 to form network, which may be used for form connections between the channels. Junctures in the channel network are accessible through knit-in openings along the sides of the fabric, enabling the electronic components to be installed and maintained. The channel 808 extends along both a length 810e and a width 810f of the fabric 810. In a first view 810a, the inner material layer 812 is positioned on the outside, while the outer material layer 816 is on the inside. In a second view 810b, the inner material layer 812 is positioned on the outside, while the outer material layer 816 is on the inside.

The stitches 810c, 810d extend through all of the material layers 812, 814, 816. A first stitch 810c is positioned a distance away from a second stitch 810d along the length 810e of the fabric. The channel access 818 extends between the first stitch 810c and the second stitch 810d along the length 810e of the fabric 810. The inner material layer 812 forms one side of the channel access 818, while the intermediate material layers 814 and the outer material layer 816 together form the other side. The intermediate material layers 814 and the outer material layer 816 together extend out from the inner material layer 812 along the width 810f to form the channel access 818.

FIG. 8B is a perspective view of a fabric 820 comprising an inner material layer 822, an outer material layer 826, and one or more intermediate material layers 824 knitted through stitches 820c, 820d together to provide a pocket 828. The pocket 828 may be used to support additional electronic components. The pocket 828 may be formed by separating the outer material layer 826 from the inner material layer 822 with interconnection points between the pocket region and the channel network. The pocket 828 extends along both a length 820e and a width 820f of the fabric 820. In a first view 820a, the inner material layer 822 is positioned on the outside, while the outer material layer 826 is on the inside. In a second view 820b, the inner material layer 822 is positioned on the outside, while the outer material layer 826 is on the inside.

The stitches 820c, 820d extend through all of the material layers 822, 824, 826. A first stitch 820c is positioned a distance away from a second stitch 810d along the length 810e of the fabric. The pocket 828 extends between the first stitch 820c and the second stitch 820d along the length 820e of the fabric 820. The inner material layer 822 forms one side of the pocket 828, while the intermediate material layers 824 and the outer material layer 826 together form the other side. The intermediate material layers 824 and the outer material layer 826 together extend out from the inner material layer 822 along the width 820f to form the pocket 828.

FIG. 8C is a perspective view of a fabric 830 comprising an inner material layer 832, an outer material layer 836, and one or more intermediate material layers 834 knitted through stitches 830c, 830d together to provide an edge flap 838. The edge flap 838 is formed along the longitudinal edges of the wearable garment. The layers are arranged in an edge flap form a highly elastic inner membrane belonging to the first closure mechanism, and a sturdier outer layer for attaching to the secondary closure mechanism, such as the closure mechanisms shown in FIGS. 10-10B.

The edge flap 838 extends along both a length 830e and a width 830f of the fabric 830. In a first view 830a, the inner material layer 832 is positioned on the outside, while the outer material layer 836 is on the inside. In a second view 830b, the inner material layer 832 is positioned on the outside, while the outer material layer 836 is on the inside.

The stitches 830c, 830d extend through all of the material layers 832, 834, 836. A first stitch 830c is positioned a distance away from a second stitch 830d along the length 830e of the fabric. The edge flap 838 extends between the first stitch 830c and the second stitch 830d along the length 830e of the fabric 830. The inner material layer 832 forms one side of the edge flap 838, while the intermediate material layers 834 and the outer material layer 836 together form the other side. The intermediate material layers 834 and the outer material layer 836 together extend out from the inner material layer 832 along the width 830f to form the edge flap 838.

FIG. 9 is a side view of a diagram of different locations 910a, 910b, 912 920, 922, 924 of electronic components for a wearable article 900, such as the wearable article of FIG. 1. The wearable article 900 decreases along a width 900a along a length 900b from a top side 904a to a bottom side 904b of the wearable article 900. A sensor 920 extends along the width 900a by the top side 904a from an outer side 902b to an inner side 904a. A sensor 924 extends along the width 900a by the bottom side 904b from the outer side 902b to the inner side 904a. A printed circuit board (PCB) 926 is located by the sensor 924 farther down the length 900b towards the bottom 904b of the wearable article 900.

Two regions 910a, 910b are located along the wearable article 900. An outer elbow region 910b is located along the outer side 902b, running from the top side 904a to the bottom side 904b along the length 900b. An inner elbow region 910a is located along the inner side 902a, running from the top side 904a to the bottom side 904b along the length 900b. A sensor 922 is located along the inner elbow region. Conductive pathways 912 run along the length 900b and the width 900a, connecting the various sensors.

The wearable garment is designed to create a seamless integration of sensing systems to collect data about the performance of the wearable garment (compression and strain) or the physical motions of the user. To match the mechanical and geometrical characteristics of the fabric, fiber-based sensors may be used that demonstrate the potential for soft and stretchable sensing integration. The electronic components may include a printed circuit board (PCB), sensors, conductive wires. Internal knitted channels with conductive wires were routed to the pocket with a PCB board, allowing the fiber-based sensors to communicate and perform signal conditioning, processing, and wireless communication.

FIG. 10 is a perspective view of a closing mechanism 1010, 1012, 1040 for a wearable article 1000, such as the wearable article of FIG. 1. The wearable article 1000 comprises a first end 1002a and a second end 1002b that extend along a length 1004a and separate from each other along a width 1004b. The closing mechanism is coupled to the first end 1000a and the second end 1000b. The closing mechanism comprises a first closing mechanism 1010 and a second closing mechanism 1040.

The first closing mechanism 1010 is a fastener, for securing the first end 1002a and the second end 1002b of the wearable article 1000. The first closing mechanism 1010 includes a zipper 1012 that secures the ends 1002a, 1002b and moves along the length 1004a. The zipper 1012 comprises a pull 1014 for interlocking the notches of the zipper 1012 and lock 1016 for securing the notches in place.

The second closing mechanism 1040 comprises one or more adjustable ratchets 1042 for applying additional pressure to the wearable article. FIG. 10A is a perspective view of a second closing mechanism 1040, wherein an outer layer 1020 is cut along the length 1004a to provide a view of the adjustable ratchets between a first edge 1022a and a second edge 1022b. The adjustable ratchets 1042 comprise one or more interwoven cords 1034 looped 1030 between one or more closed-hook fasteners 1032 attached to one or more adjustable ratchets 1042.

The closed-hook fasteners 1032 are dispersed along the length 1004a of the wearable article 1000. The interwoven cords 1034 are attached into the inner material layer 1024, such as the inner material layer 300 shown in FIG. 3, and extend to loop between the closed-hook fasteners 1032. FIG. 10B illustrates a first adjustable ratchet 1042 on the wearable article 1000. The user rotates the adjustable ratchets 1042 to move the interwoven cords 1034 along the hook fasteners 1032 to tighten or loosen the interwoven cords 1034, ultimately tightening the wearable article 1000 to apply additional pressure from the wearable article 1000 to the user.

By dividing the closure mechanism into two mechanisms, the compression forces are spread over two closure mechanisms. Accordingly, the multi-layer fabric architecture distributes pressure evenly over the user while allowing the wearable article to be easily put on and off. The desired level of pressure applied by wearable garment to the user creates challenges for the ease and speed of donning and doffing the wearable garment. A traditional garment closure mechanisms are not fully applicable in high pressure scenarios, often requiring significant assistance during the donning process. Rather than a single closure mechanism, the wearable garment utilizes the multilayered knit construction to separate the closure into different mechanisms, distributing the compression forces into two closure closing mechanisms to speed the donning process to under one minute and enable a user to put on the wearable article without assistance.

Although reference is made herein to particular materials, it is appreciated that other materials having similar functional and/or structural properties may be substituted where appropriate, and that a person having ordinary skill in the art would understand how to select such materials and incorporate them into embodiments of the concepts, techniques, and structures set forth herein without deviating from the scope of those teachings.

Various embodiments of the concepts, systems, devices, structures, and techniques sought to be protected are described herein with reference to the related drawings. Alternative embodiments can be devised without departing from the scope of the concepts, systems, devices, structures, and techniques described herein. It is noted that various connections and positional relationships (e.g., over, below, adjacent, etc.) are set forth between elements in the following description and in the drawings. These connections and/or positional relationships, unless specified otherwise, can be direct or indirect, and the described concepts, systems, devices, structures, and techniques are not intended to be limiting in this respect. Accordingly, a coupling of entities can refer to either a direct or an indirect coupling, and a positional relationship between entities can be a direct or indirect positional relationship.

As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s). The following definitions and abbreviations are to be used for the interpretation of the claims and the specification. As used herein, the terms “comprises,” “comprising, “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs. The term “one or more” is understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal,” “top,” “bottom,” and derivatives thereof shall relate to the described structures and methods, as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. A wearable article, comprising:
a fabric comprising:
an inner material layer which forms an inner surface of the wearable article;
an outer material layer which forms an outer surface of the wearable article; and
one or more intermediate material layers disposed between the inner material layer and outer material layer with the inner material layer, outer material layer, and one or more intermediate material layers knitted together to provide a combination of two or more of: two or more compression zones; two or more mobility zones; two or more materials; or one or more electronic components.

2. The wearable article of claim 1, wherein the inner material layer, outer material layer, and one or more intermediate material layers are knitted together through one or more of a front stitch, a tuck stitch, or a float stitch.

3. The wearable article of claim 1, wherein the inner material layer, outer material layer, and one or more intermediate material layers knitted together to provide one or more spaces having a size and a shape selected to hold one or more electronic components.

4. The wearable article of claim 1, wherein one or more tuck stitches form the two or more compression zones, wherein the two or more compression zones of different compression form a gradient of pressure along a length of the fabric.

5. The wearable article of claim 1, wherein the inner material layer and the one or more intermediate material layers are made from a first material, wherein the outer material layer is made from a second material different from the first material.

6. The wearable article of claim 1, wherein the one or more intermediate material layers has a thickness greater than a thickness of the inner material layer, wherein the inner material layer or the one or more intermediate material layers comprises one of a polymer, a copolymer, or a polyamide.

7. The wearable article of claim 1, wherein the outer material layer comprises a plurality of fibers comprising one of medium density polyethylene (MDPE), linear low density polyethylene (LLDPE), bicomponent fiber, or polyamide.

8. The wearable article of claim 1, wherein the fabric has a first end and a second end and the wearable article further comprises a closing mechanism coupled to the first end and the second end of the fabric.

9. The wearable article of claim 8, wherein the closing mechanism comprises a first closing mechanism and a second closing mechanism, wherein the first closing mechanism is a fastener for securing the first end and the second end of the fabric.

10. The wearable article of claim 9, wherein the second closing mechanism comprises one or more adjustable ratchets for applying additional pressure to the fabric, wherein the adjustable ratchets comprises one or more interwoven cords looped between one or more closed-hook fasteners attached to one or more ratchets.

11. A wearable article, comprising:
a fabric comprising:
an inner material layer which forms an inner surface of the wearable article;
an outer material layer which forms an outer surface of the wearable article; and
one or more intermediate material layers disposed between the inner material layer and outer material layer with the inner material layer, outer material layer, and one or more intermediate material layers knitted together with flatbed knitting to provide a combination of two or more of: two or more compression zones; two or more mobility zones; two or more materials; or one or more electronic components.

12. The wearable article of claim 11, wherein the inner material layer, outer material layer, and one or more intermediate material layers knitted together to provide one or more spaces having a size and a shape selected to hold one or more electronic components, wherein the one or more spaces comprise one or more of: channels; channel accesses; pockets; or edge flaps.

13. The wearable article of claim 11, wherein the electronic components comprise one or more sensors, a wire system for communicating with the sensors, or one or more printed circuit boards.

14. The wearable article of claim 11, wherein the inner material layer and one or more intermediate material layers are formed from the same material and the outer material layer is formed from a different material.

15. The wearable article of claim 11, wherein the one or more intermediate material layers has a thickness greater than a thickness of the inner material layer, wherein the inner material layer or the one or more intermediate material layers comprises one of a polymer, a copolymer, or a polyamide.

16. The wearable article of claim 11, wherein the outer material layer comprises a plurality of fibers comprising one of medium density polyethylene (MDPE), linear low density polyethylene (LLDPE), bicomponent fiber, or polyamide.

17. The wearable article of claim 11, wherein the outer material layer is made out of a medium density polyethylene (MDPE), wherein the two or more mobility zones includes one or more padding zones and one or more mobility zones knitted into the outer material layer, wherein the one or more padding zones and one or more mobility zones comprises one or more of a linear low density polyethylene (LLDPE), a bicomponent fiber, or a polyamide.

18. The wearable article of claim 11, wherein the fabric has a first end and a second end and the wearable article further comprises a closing mechanism coupled to the first end and the second end of the fabric.

19. The wearable article of claim 18, wherein the closing mechanism comprises a first closing mechanism and a second closing mechanism, wherein the first closing mechanism is a fastener for securing the first end and the second end of the fabric.

20. The wearable article of claim 19, wherein the second closing mechanism comprises one or more adjustable ratchets for applying additional pressure to the fabric, wherein the adjustable ratchets comprises one or more interwoven cords looped between one or more closed-hook fasteners attached to one or more ratchets.
